(19) United States
(12) Patent Application Publication
(10) Pub. No.: US 2007/0071289 A1
(43) Pub. Date: Mar. 29, 2007

(54) Feature point detection apparatus and method

(75) Inventors: Tomoyuki Takeguchi, Kanagawa-ken (JP); Mayumi Yuasa, Kanagawa-ken (JP); Osamu Yamaguchi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/504,599

(22) Filed: Aug. 16, 2006

(30) Foreign Application Priority Data
Sep. 29, 2005 (JP) P2005-285597

(51) Int. Cl. G06K 9/00

(52) U.S. Cl. 382/118

(57) ABSTRACT

A first template of a first feature point of an object, a second template of a second feature point of the object, and a third template of a combination of the first feature point and the second feature point are previously stored. A candidate detection unit detects a plurality of first candidates of the first feature point and a plurality of second candidates of the second feature point from an image of the object. A first pattern recognition unit extracts a plurality of third candidates from the plurality of first candidates based on a first similarity between each first candidate and the first template, and extracts a plurality of fourth candidates from the plurality of second candidates based on a second similarity between each second candidate and the second template. A second pattern recognition unit generates a plurality of first combinations of each third candidate and each fourth candidate, and extracts a second combination from the plurality of first combinations based on a third similarity between each first combination and the third template.

### CROSS-REFERENCE TO RELATED APPLICATIONS

This application is based upon and claims the benefit of priority from prior Japanese Patent Application No.2005-285597, filed on Sep. 29, 2005; the entire contents of which are incorporated herein by reference.

### FIELD OF THE INVENTION

The present invention relates to a feature point detection apparatus and a method for detecting facial feature points such as pupils or mouth edges from a person facial image.

### BACKGROUND OF THE INVENTION

Citations 1 (Japanese Patent No.3279913) and 2 (Japanese Patent Disclosure (Kokai) No.2004-252511) relate to method for detecting facial feature points from a facial image. In the citation 1, candidate points of facial feature are restrictively selected using a circle separability filter, and a group of four candidate points of pupils and nostrils matched with geometric condition is selected from all candidate points. Each point of the group is compared with a template (standard pattern) near the point, and a similarity between each point and the template is calculated. By adding each similarity of the four points, four points of pupils and nostrils are determined. However, in this method, the four points of pupils and nostrils must be simultaneously detected at the first time.

In the citation 2, from feature point candidates obtained by the corner detection method, a combination of points matched with a projection constant quantity (previously calculated) is detected as six points of corners of both pupils and both edges of the mouth. However, in order to calculate the projection constant quantity, at least five feature points located on the same plain (face image) are necessary.

As mentioned-above, in the background art, in order to determine a correct position of the feature point, many feature points of different parts on the facial image are necessary. However, the feature points often cannot be detected by photographing direction of the face or the user's facial direction.

### SUMMARY OF THE INVENTION

The present invention is directed to an apparatus and a method for correctly detecting feature points from a facial image by one point-normalization pattern recognition and multipoint-normalization pattern recognition.

According to an aspect of the present invention, there is provided an apparatus for detecting feature points, comprising: a storage unit configured to store a first template of a first feature point of an object, a second template of a second feature point of the object, and a third template of a combination of the first feature point and the second feature point; an image input unit configured to input an image of the object; a candidate detection unit configured to detect a plurality of first candidates of the first feature point and a plurality of second candidates of the second feature point from the image; a first pattern recognition unit configured to extract a plurality of third candidates from the plurality of first candidates based on a first similarity between each first candidate and the first template, and to extract a plurality of fourth candidates from the plurality of second candidates based on a second similarity between each second candidate and the second template; and a second pattern recognition unit configured to generate a plurality of first combinations of each third candidate and each fourth candidate, and to extract a second combination from the plurality of first combinations based on a third similarity between each first combination and the third template.

According to another aspect of the present invention, there is also provided a method for detecting feature points, comprising: storing in a memory, a first template of a first feature point of an object, a second template of a second feature point of the object, and a third template of a combination of the first feature point and the second feature point; inputting an image of the object; detecting a plurality of first candidates of the first feature point and a plurality of second candidates of the second feature point from the image; extracting a plurality of third candidates from the plurality of first candidates based on a first similarity between each first candidate and the first template; extracting a plurality of fourth candidates from the plurality of second candidates based on a second similarity between each second candidate and the second template; generating a plurality of first combinations of each third candidate and each fourth candidate; extracting a second combination from the plurality of first combinations based on a third similarity between each first combination and the third template.

According to still another aspect of the present invention, there is also provided a computer program product, comprising: a computer readable program code embodied in said product for causing a computer to detect feature points, said computer readable program code comprising instructions of: storing in a memory, a first template of a first feature point of an object, a second template of a second feature point of the object, and a third template of a combination of the first feature point and the second feature point; inputting an image of the object; detecting a plurality of first candidates of the first feature point and a plurality of second candidates of the second feature point from the image; extracting a plurality of third candidates from the plurality of first candidates based on a first similarity between each first candidate and the first template; extracting a plurality of fourth candidates from the plurality of second candidates based on a second similarity between each second candidate and the second template; generating a plurality of first combinations of each third candidate and each fourth candidate; and extracting a second combination from the plurality of first combinations based on a third similarity between each first combination and the third template.

### BRIEF DESCRIPTION OF THE DRAWINGS

FIG. 1 is a block diagram of the feature point detection apparatus according to a first embodiment.

FIG. 2 is a flow chart of processing of the feature point detection method according to the first embodiment.

FIG. 3 is a block diagram of the feature point detection apparatus according to a modification of the first embodiment.

FIG. 4 is a block diagram of the feature point detection apparatus according to a second embodiment.

FIG. 5 is a block diagram of the feature point detection apparatus according to a third embodiment.

FIG. 6 is a schematic diagram of a pattern detection method of one point-normalization pattern recognition.

FIG. 7 is a schematic diagram of a pattern detection method of two points-normalization pattern recognition.

FIG. 8 is a schematic diagram of a pattern detection method of three points-normalization pattern recognition.

### DETAILED DESCRIPTION OF THE EMBODIMENTS

Hereinafter, various embodiments of the present invention will be explained by referring to the drawings. The present invention is not limited to the following embodiments.

(First Embodiment)

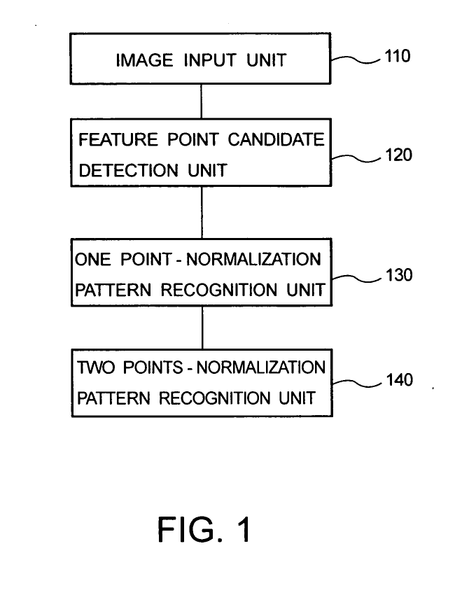

FIG. 1 is a block diagram of the feature point detection apparatus according to the first embodiment. In the present embodiment, both pupils are detected as feature points from a face image.

The feature point detection apparatus includes an image input unit 110, a feature point candidate detection unit 120, a one point-normalization pattern recognition unit 130, and a two points-normalization pattern recognition unit 140. The image input unit 110 captures an image to be processed. The feature point candidate detection unit 120 detects a candidate point of a pupil from the input image. The one point-normalization pattern recognition unit 130 selects the candidate point of the pupil by matching a circumference pattern of each candidate point of the pupil with a template of the pupil. The two points-normalization pattern recognition unit 140 normalizes a pattern including a pair of candidate points of both (right and left) pupils, and detects a pair of pupils by matching a normalized pattern of the pair with a template of both pupils.

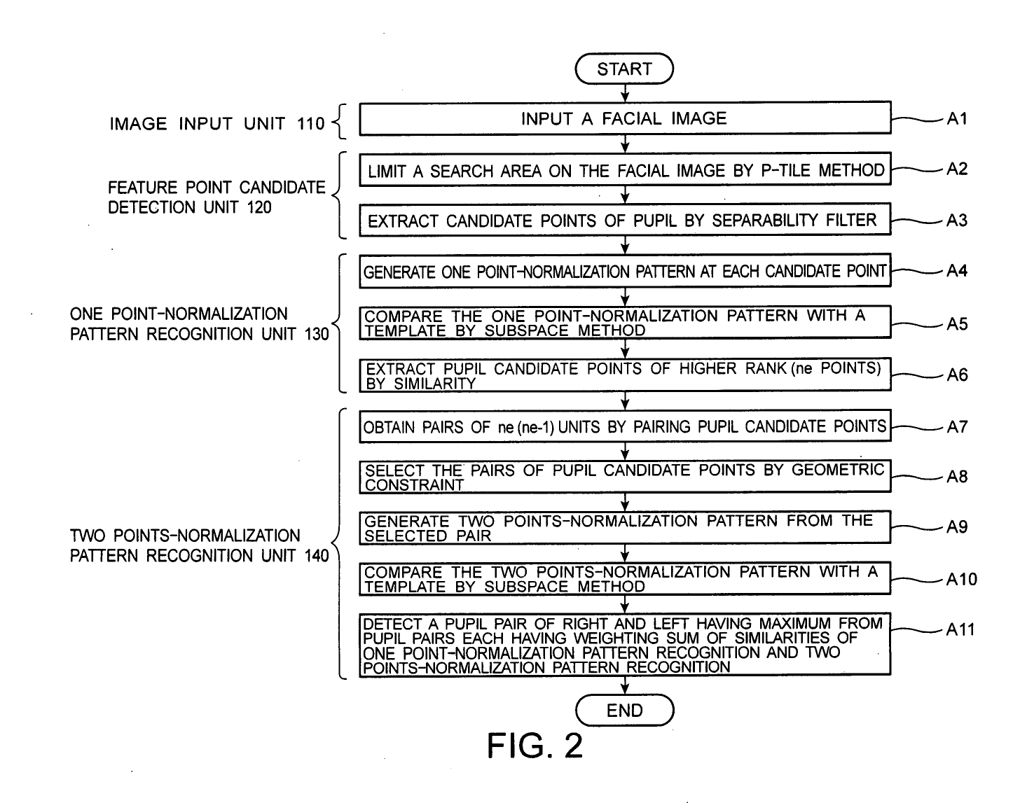

Next, operation of the feature point detection apparatus is explained by referring to FIGS. 1 and 2. FIG. 2 is a flow chart of processing of the feature point detection apparatus of the first embodiment.

The image input unit 110 captures a digital image including a facial area of a person as an object of feature point detection by using, for example, a digital camera or a scanner, or an existing digital file (A1).

The feature point candidate detection unit 120 selects candidate points of both pupils from an image (obtained by the image input unit 110). In this case, it takes a long time to process all areas of the input image. Accordingly, by using P-tile method, pixels having low brightness are set as a search area on the input image. A threshold value necessary for the P-tile method is determined by a previous test in order not to miss positions of both pupils (A2). For example, the P-tile method is disclosed in “Handbook for image analysis (New version); Mikio TAKAGI et al., University of Tokyo Press, PP.1520-1521, Sep.2004”.

As for a search area selected by P-tile method, by using a separability filter (disclosed in the citation 1), an output value of separability of each pixel is obtained. After the output value of separability of each pixel is smoothed by the Gaussian filter, a local maximum point of the output value is extracted as candidate points of both pupils (A3). The one point-normalization pattern recognition unit 130 extracts patterns centered around the candidate points (obtained by the feature point candidate detection unit 120).

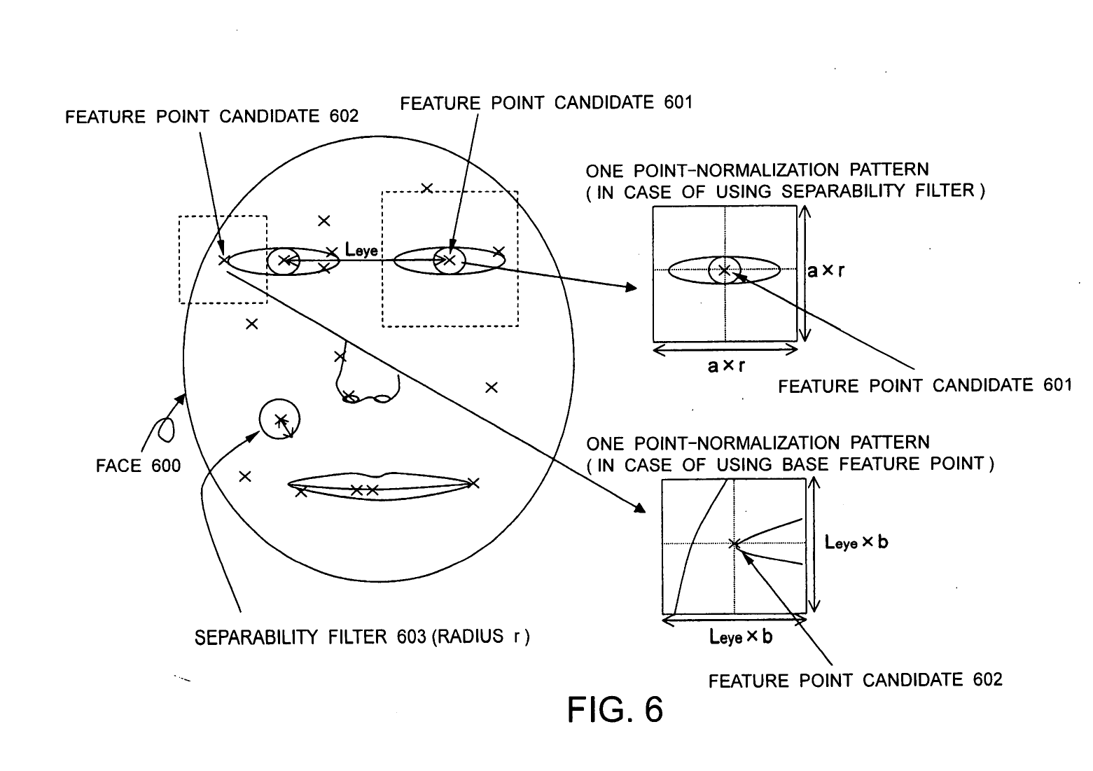

FIG. 6 shows a facial image 600 on which a plurality of feature point candidates are distributed (the left side of FIG. 6), one point-normalization pattern extracted from the feature point candidate 601 using the separability filter (the right upper side of FIG. 6), and two points-normalization pattern extracted from the feature point candidate 602 using a base feature point (the right lower side of FIG. 6).

For example, in case that a radius of a circle of the separability filter 603 (used by the feature point candidate detection unit 120) is r, as shown in FIG. 6 (the right upper side), a pattern of size “a×r” centering around the feature point candidate 601 is extracted along a horizontal/vertical direction. A multiple “a” is set to include a pupil area by a previous test based on a size of the separability filter (A4). Next, a similarity between a pattern extracted at each candidate point and a template (previously registered) centering around some pupil feature point is calculated. In case of similarity calculation, a pattern matching method such as the subspace method and the projection distance method are used (A5). For example, the subspace method is disclosed in “Wakariyasui Pattern Recognition; Ken-ichiro ISHII et al., Ohmsha, August 1998”.

“n” points of higher rank of the similarity are extracted from all candidate points. The number “n” of points (as a threshold) is determined by a previous test as the minimum not to miss the candidate point near a correct position. Finally, the one point-normalization pattern recognition unit 130 outputs “nₑ” points as pupil candidate points and the similarity of each candidate point (A6).

The two points-normalization pattern recognition unit 140 extracts two points from nₑ pupil candidate points as the right pupil and the left pupil, and sets the two points as a pair of both pupil candidates. The right pupil and the left pupil are not located at the same position. Accordingly, a number of the pair of both pupil candidates is “nₑ×(nₑ−1)” (A7).

Furthermore, if a size or a direction of the face is previously estimated, by limiting a distance between two candidate points of both pupils, and an angle between a vector linking the two candidate points and a horizontal direction of the image, a pair of both pupil candidates not matched with this limitation can be excluded. As a result, incorrect candidates are excluded and processing can be quickly executed (A8).

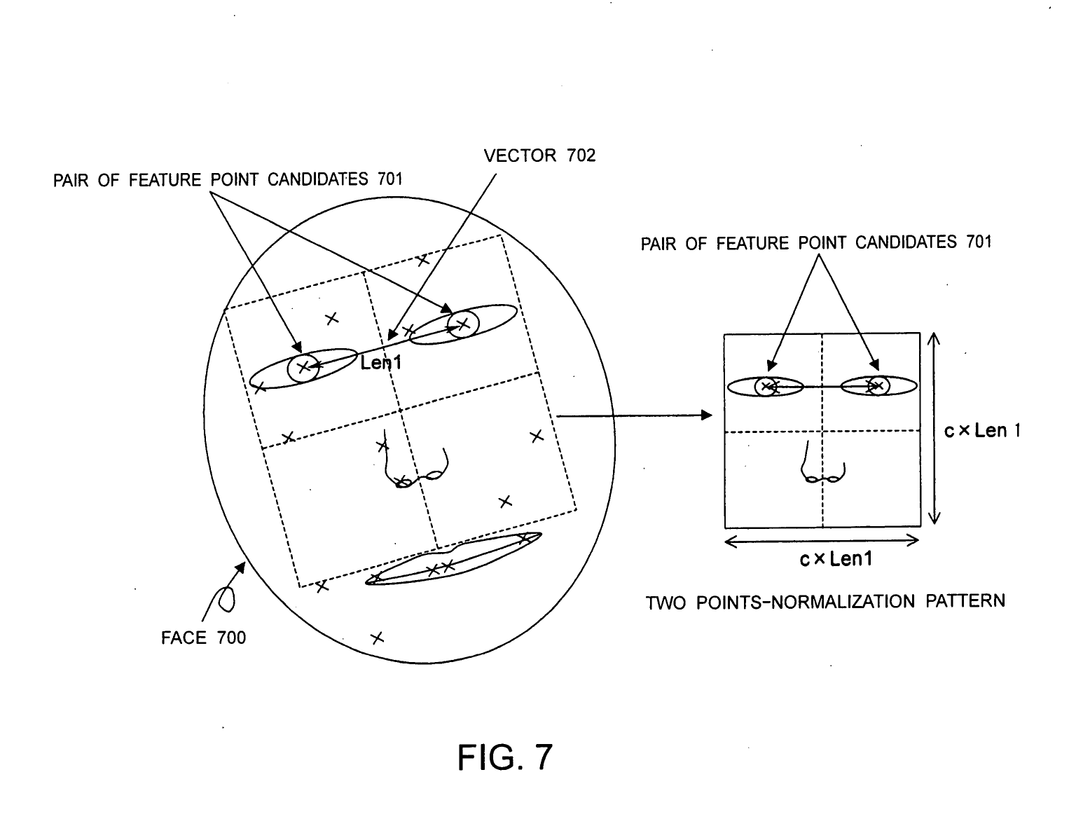

Next, a circumference pattern including two points is normalized using a distance and a vector between two points of a pair of both pupil candidates. FIG. 7 shows a facial image 700 on which the pattern including two points of the pair 701 (two pupil candidates) is normalized (the left side of FIG. 7), and a two points-normalization pattern extracted (the right side of FIG. 7).

For example, if the face 700 leans as shown in the left side of FIG. 7, by extracting a pattern based on a vector 702 between the pair of feature point candidates 701 and a vector perpendicular to the vector 702, a direction of the pattern is corrected. Furthermore, in case that a distance between the pair of feature point candidates 701 is “Lₑₙ1”, by extracting a pattern of size “c×Lₑₙ1” shown in the right side of FIG. 7, personal difference of the distance between both pupils can be disregarded. A constant c of the size of the pattern is determined to include a facial area by a previous test. Accordingly, in comparison with one point-normalization pattern, a pattern of which direction and size are normalized can be extracted (A9). Next, a similarity between the two points-normalization pattern (of the pair of both pupil candidates) and a template (previously registered) of both pupils (the right pupil and the left pupil) is calculated. In case of calculating the similarity, in the same way as the one point-normalization pattern recognition unit 130, the pattern matching method such as the subspace method or the projection distance method is used (A10). Next, a weighting sum of the similarity of the two points-normalization pattern of a pair (of both pupil candidate points), and the similarity of one point-normalization pattern of one candidate point of the right pupil in the pair, and the similarity of one point-normalization pattern of one candidate point of the left pupil in the pair, is calculated, and one pair of pupil candidate points having the maximum weighting sum is selected as a pair of right and left pupils (A11).

In this way, in the feature point detection apparatus of the first embodiment, the feature point candidate detection unit 120 detects pupil candidate points from a digital image including a person's face captured by the image input unit. After the one point-normalization pattern recognition unit selects the pupil candidate points, the two points-normalization pattern recognition unit detects a pair of right and left pupils from pairs of pupil candidate points. A pattern normalized using a plurality of points is stable for transformation such as scale, rotation, or affine transformation. In the background art, in case of using many points, a number of combination of pupil candidate points exponentially increases, and the calculation cost also increases.

In the first embodiment, this problem is solved. Briefly, in the feature point detection apparatus of the first embodiment, before evaluating a combination of feature points detected from the image, the combination is restrictively selected by one point-normalization pattern recognition and two points-normalization pattern recognition. Accordingly, the number of combinations can be reduced.

Furthermore, by calculating the weighting sum from the similarity by one point-normalization pattern and the similarity by two point-normalization pattern, the pair of feature point candidates is restrictively selected from all pairs of feature point candidates. Accordingly, the pair of feature points can be detected without error.

Briefly, in two point-normalization pattern recognition, in addition to a similarity calculated by the two points-normalization pattern recognition, by using a similarity calculated by one point-normalization pattern recognition, the two points-normalization pattern is evaluated. Accordingly, accuracy of detection of feature points rises.

(Modification 1)

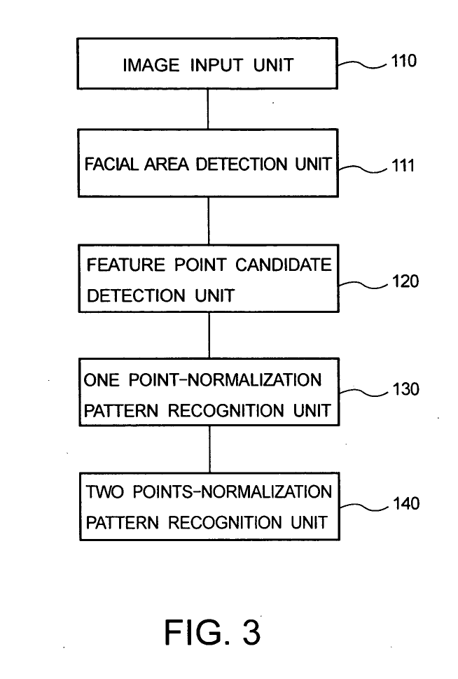

As a method for limiting a search area, as shown in FIG. 3, a facial area detection unit 111 is inserted before the feature point candidate detection unit 120. The facial area detection unit 111 detects a facial area. Briefly, after limiting a search area of pupils on the facial area, the P-tile method can be applied.

For example, the facial area detection unit 111 detects a facial area by the method disclosed in “Proposal of Joint Haar-like feature suitable for face detection: Takeshi MITA et al., Ninshiki-Rikai Symposium of Image (MIRU2005), pp.104-111, July 2005”.

In the first embodiment, distinction of right and left pupils is not included in a search area of a pupil and pupil candidate points obtained by the one point-normalization pattern recognition unit. However, in case of guiding the facial area detection unit 111, by setting each search area of right and left pupils without overlap on the facial area, left pupil candidate points of “nₗₑ” units and right pupil candidate points of “nᵣₑ” units are respectively obtained. In this case, pairs of “nₗₑ×nᵣₑ” unit are obtained as a pair of right and left pupil candidate points.

(Modification 2)

As a method for processing various sizes of pupils, a method for setting a plurality of the separatability filters each of which size is different is explained.

A size of a pupil depends on a size of a face photographed. Furthermore, the size of the pupil corresponding to the size of the face is personally different. In order to cope with variation of the size of the pupil, the separability filters of several sizes can be used.

In the modification 2, the separability filters of each size are set. In processing of the feature point candidate detection unit 120, the one point-normalization pattern recognition unit 130, and the two points-normalization pattern recognition unit 140, all pairs each having both pupils are obtained by the separability filters of each size. Finally, one pair of both pupils having the maximum weighting sum is selected from the pairs.

(Second embodiment)

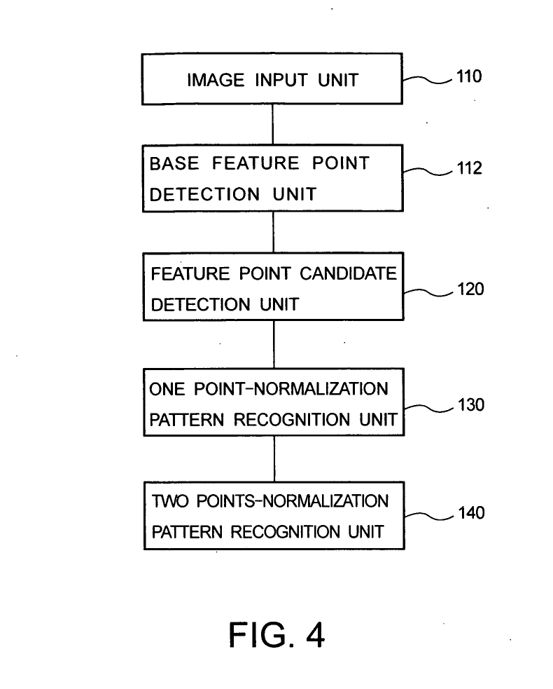

FIG. 4 is a block diagram of the feature point detection apparatus of the second embodiment. In the second embodiment, a method for detecting the corner of the eye (the outside corner and the inside corner of the eye on a face) as feature points is explained.

The feature point detection apparatus includes an image input unit 110, a base feature point detection unit 112, a feature point candidate detection unit 120, a one point-normalization pattern recognition unit 130, and a two points-normalization pattern recognition unit 140. The image input unit 110 captures an image to be processed. The base feature point detection unit 112 detects a feature point as a base point. The feature point candidate detection unit 120 detects a candidate point of the corners of the eye from the input image. The one point-normalization pattern recognition unit 130 selects the candidate point of the corner of the mouth by matching a circumference pattern of each candidate point with a template of the corner of the eye. The two points-normalization pattern recognition unit 140 normalizes a pattern including a pair of candidate points of both corners of the eye (the outside corner and the inside corner), and detects a pair of both corners of the eye by matching a normalized pattern of the pair with a template of both corners of the eye.

The image input unit 110 captures a digital image including a facial area of a person as an object of feature point detection by using, for example, a digital camera or a scanner, or an existing file.

The base feature point detection unit 112 detects a base feature point useful for detecting the corner of the eye from feature points except for the corner of the eye. In the second embodiment, both pupils are used as the base feature point. The base feature point detection unit 112 detects both pupils using the feature point detection apparatus of the first embodiment. Accordingly, the base feature point detection unit 112 outputs positions of both pupils on the image.

The feature point candidate detection unit 120 extracts candidate points of the corner of the eye. In the right and left pupils, four points of the corner of the eye exist, and each point is independently processed. Hereinafter, detection of the corner of the eye (the outside corner and the inside corner) from one eye is explained.

First, by using positions of both pupils (obtained by the base feature point detection unit 112), a search area of the corner of the eye is set.

In the second embodiment, points of the corner of the eye (the outside edge and the inside edge) are modeled as two cross points between edges of an upper eyelid and edges of a lower eyelid. In order to correctly detect the two cross points, feature point candidates are extracted using the corner detection method. An example corner detection method is disclosed in “A Combined Corner and Edge Detector; C. Harris et al., Proceedings of 4th Alvey Vision Conference, pp.147-155, 1988”.

The corner detection method is applied to each pixel in the search area of the corner of the eye. After smoothing by applying the Gaussian filter to an output value of a corner degree, a local maximum point of the output value is extracted as a candidate point of the corner of the eye.

In order to use the corner detection method, a scale of a corner as an extraction object may be determined. In order to detect the corner matched with a size of the corner of the eye, size information of the face is necessary. A distance between the pupils is generally in proportion to a size of the face. Accordingly, the scale is determined based on the distance between the pupils.

In the one point-normalization pattern recognition unit 130, first, each pattern around a center candidate point of the corner of the eye (obtained by the feature point candidate detection unit 120) is extracted. In case that the distance between both pupils (detected by the base feature point detection unit 112) is “L_{eye}”, as shown in the right lower side of FIG. 6, a pattern of size “L_{eye}×b” centered around the candidate point 602 is extracted along vertical/horizontal directions of the image. A multiple “b” to determine the size is set to include a circumference of the corner of the eye by a previous test.

A similarity between the pattern of each candidate point and a template (previously registered) centered at the corner of the eye is calculated. In order to calculate the similarity, a pattern matching method such as the subspace method (above-mentioned) or the projection distance method is used.

“n” points of high rank of the similarity are extracted from each candidate point. The number of points “n” is determined by a previous test as a minimum not to miss the candidate point near a correct answer. As a result, the one point-normalization pattern recognition unit 130 outputs “nₒᵤₜ” candidate points of the outside corner of the eye, “nᵢₙ” candidate points of the inside corner of the eye, and the similarity of each candidate point.

The two points-normalization pattern recognition unit 140 sets a pair of the corner of the eye by combining one candidate point of the outside corner of the eye with one candidate point of the inside corner of the eye. A number of the pairs is “nₒᵤₜ×nᵢₙ”

By using the pair of the corner of the eye, a distance between a candidate point of the outside corner and a candidate point of the inside corner, and a vector between these two candidate points can be calculated. In the same way, by using positions of both pupils (obtained by the base feature point detection unit 112), a distance and a vector between both pupils can be calculated. Accordingly, a ratio of the distance between both pupils to the distance between the candidate point of the outside corner and the candidate point of the inside corner, and an angle between the vector between both pupils and the vector between the two candidate points, are restrictively set. As a result, a pair of the outside corner/inside corner of the eye having high possibility of geometrical error is excluded, and the processing can be quickly executed.

In the same way as the two points-normalization pattern recognition unit of the first embodiment, a pair of candidate points of the outside corner/inside corner of the eye can be extracted by normalizing a pattern of the pair using the distance/vector between the candidate points. Accordingly, in comparison with the one point-normalization pattern, a pattern having size/direction correctly normalized can be extracted.

A similarity between the two points-normalization pattern of the pair of candidate points of the outside corner/inside corner of the eye and a template (previously registered) of a normalization pattern of the outside corner/inside corner of the eye is calculated. In order to calculate the similarity, in the same way as in the one point-normalization pattern recognition unit, a pattern matching method such as the subspace method (above-mentioned) or the projection distance method is used.

A weighting sum of the similarity of the two points-normalization pattern of the pair, the similarity of the candidate point of the outside corner of the eye (in the pair), and the similarity of the candidate point of the inside corner of the eye (in the pair) are calculated. A pair having the maximum weighting sum is selected from all pairs as the outside corner/inside corner of the eye.

By independently executing the above-processing for the outside corner/inside corner of the right eye and the left eye, the outside corner/inside corner of the right eye and the left eye are obtained. Furthermore, one point-normalization template pattern for the right eye and one point-normalization template pattern for the left eye may be reversed as right and left. In this case, one point-normalization template pattern for the left eye and one point-normalization template pattern for the right eye can be easily prepared.

As mentioned-above, in the feature point detection apparatus of the second embodiment, the base feature point detection unit detects a pupil position from a digital image including a person's face, a feature point candidate detection unit detects candidate points of the outside corner/inside corner of the eye, the one point-normalization pattern recognition unit selects the candidate points of the outside corner/inside corner of the eye, and the two points-normalization pattern recognition unit detects one pair from pairs each having candidate points of the outside corner/inside corner of the eye.

A pattern normalized using many points is stable for transformations such as scale, rotation, or affine transformation. However, in background methods, by using many points, a number of combinations of candidate points of the corner of the eye exponentially increases, and the calculation cost also increases.

In the second embodiment, this problem is solved. Briefly, in the feature point detection apparatus of the present embodiment, before evaluating a combination of feature points detected from the image, the combination is selected by one point-normalization pattern recognition. Accordingly, the number of combinations can be reduced.

Furthermore, by calculating the weighting sum from the similarity by one point-normalization pattern and the similarity by two point-normalization pattern, the pair of candidate points of the corner of the eye is restrictively selected from all pairs of candidate points. Accordingly, the pair of candidate points of the corner of the eye can be detected without error.

Briefly, in two point-normalization pattern recognition, in addition to the similarity calculated by the two points-normalization pattern recognition, by using the similarity calculated by one point-normalization pattern recognition, pattern recognition of each pair of candidate points is evaluated. Accordingly, accuracy of detection of candidate points rises.

(Modification)

As a modification, a feature quantity used for one point-normalization pattern and two points-normalization pattern is explained.

As mentioned-above, in the second embodiment, the outside corner/inside corner of the eye is regarded as two cross points between edges of the upper eyelid and edges of the lower eyelid. Briefly, edge information is important to determine position of the outside corner/inside corner of the eye. Accordingly, as a method for generating a pattern, in addition to a light and shade pattern using pixel brightness, a gradient pattern using pixel gradient is used. Concretely, by following equations, patterns of three kinds (a brightness pattern, a gradient pattern along a horizontal direction, and a gradient pattern along a vertical direction) are generated.

$$\begin{matrix} {II}_{i} = \frac{{p}_{i}}{( {P}_{max} - {P}_{min} )} \\ XI = \frac{{cos}^{- 1} ( ▽ {P}_{i} \cdot {v}_{x} )}{} \\ {YI}_{i} = \frac{{cos}^{- 1} ( ▽ {P}_{i} \cdot {v}_{y} )}{}\end{matrix}$$

In the above equation, each parameter represents as follows.
pᵢ: brightness of pixel i in an area extracted with normalization
Pₘₐₓ: maximum brightness in the area
Pₘᵢₙ: minimum brightness in the area
∇Pᵢ: unit gradient vector of pixel i
νₓ: unit vector of extracted pattern along x direction
ν_{y}: unit vector of extracted pattern along y direction
IIᵢ: light and shade pattern
XIᵢ: gradient pattern along horizontal direction
YIᵢ: gradient pattern along vertical direction

In above equation, all patterns have a value from “0” to “1”. Briefly, the light and shade pattern IIᵢ is defined such that a brightness Pᵢ of pixel i of an area (extracted with normalization) is divided by the difference between the maximum brightness Pₘₐₓ of the area and the minimum brightness Pₘᵢₙ of the area. The gradient pattern XIᵢ along the horizontal direction is defined such that an inverse cosine of x-element of the unit gradient vector ∇Pᵢ of pixel i is divided by the circular constant. The gradient pattern YIᵢ along the vertical direction is defined such that an inverse cosine of y-element of the unit gradient vector ∇Pᵢ of pixel i is divided by the circular constant.

As for these patterns, a template is independently prepared, and matching processing is independently executed. By setting the weighting sum of each similarity as a final similarity, pattern recognition that the gradient direction is taken into consideration is possible. Even if it is difficult that a feature point is extracted by brightness information directly (such as a dark image), the feature point can be correctly detected.

(Third embodiment)

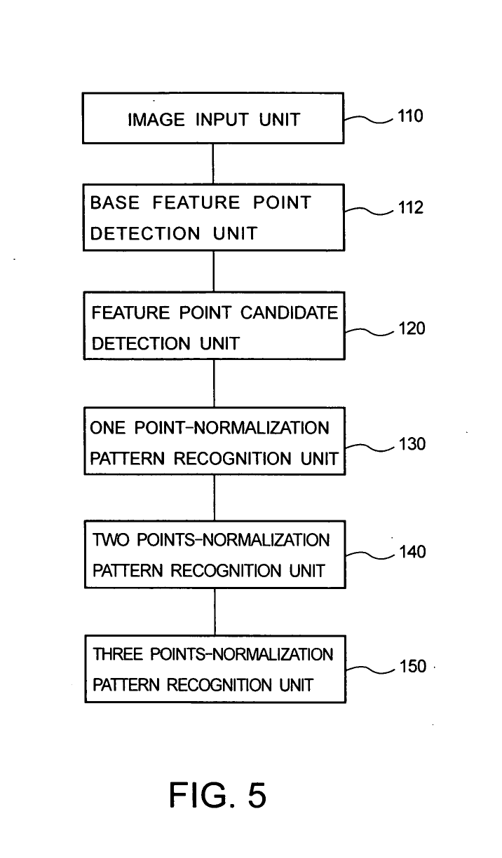

FIG. 5 is a block diagram of the feature point detection apparatus of the third embodiment. In the third embodiment, a mouth edge is detected as a feature point.

The feature point detection apparatus includes an image input unit 110, a base feature point detection unit 112, a feature point candidate detection unit 120, a one point-normalization pattern recognition unit 130, a two points-normalization pattern recognition unit 140, and a three points-normalization pattern recognition unit 150. The image input unit 110 captures an image to be processed. The base feature point detection unit 112 detects a base point (feature point) necessary for detecting a mouth edge. The feature point candidate detection unit 120 detects a candidate point of the mouth edge from the input image. The one point-normalization pattern recognition unit 130 selects the candidate point of the mouth edge by matching a circumference pattern of each candidate point with a template of the mouth edge. The two points-normalization pattern recognition unit 140 normalizes a pattern including a pair of candidate points of both mouth edges (the right side mouth edge and the left side mouth edge), and detects a pair of candidate points of both mouth edges by matching a normalized pattern of the pair with a template of both mouth edges. The three points-normalization pattern recognition unit 150 normalizes a pattern including three points (the pair of candidate points of both mouth edges, a middle point between the base feature points), and detects a pair of both mouth edges by matching a normalized pattern including the three points with a template of the three points.

The image input unit 110 captures a digital image including a facial area of a person as an object of feature point detection by using, for example, a digital camera, a scanner, or an existing file.

The base feature point detection unit 112 detects a base feature point useful for detecting the mouth edge from feature points except for the mouth edge. In the third embodiment, both pupils are used as the base feature point. The base feature point detection unit 112 detects both pupils using the feature point detection apparatus of the first embodiment. Accordingly, the base feature point detection unit 112 outputs positions of both pupils on the image.

A position of the base feature point is desirably near a position of a feature point to be detected and has few errors because a search area is easily restricted. However, in the present invention, the base feature point is not limited to both pupils. For example, both nostrils may be the base feature points.

The feature point candidate detection unit 120 extracts candidate points of both mouth edges. First, by using positions of both pupils (obtained by the base feature point detection unit 112), the feature point candidate detection unit 120 restricts a search area of both mouth edges on the image.

In the second embodiment, it is assumed that a cross point between edges of the upper lip and edges of the lower lip is a mouth edge. In order to correctly detect the cross point, the feature point candidate is detected using the corner detection method as mentioned-above. The corner detection method is applied to each pixel in the search area of the mouth edge. After smoothing by applying the Gaussian filter to an output value of a corner degree, a local maximum point of the output value is extracted as a candidate point of the mouth edge.

In order to use the corner detection method, a scale of a corner as an extraction object may be determined. In order to detect the corner matched with a size of the mouth edge, size information of the face is necessary. A distance between the pupils (obtained by the base feature point detection unit 112) is generally in proportion to a size of the face. Accordingly, the scale is determined based on the distance between the pupils.

The one point-normalization pattern recognition unit 130 extracts a circumference pattern centered around a candidate point of the mouth edge (obtained by the feature point candidate detection unit 120).

In the same way as in the one point-normalization pattern recognition unit of the second embodiment, based on a distance between the pupils (detected by the base feature point detection unit 112), a size of the extraction object is set to include a circumference pattern of the mouth edge. This size may be experimentally determined.

A similarity between a pattern of each candidate point and a template (previously registered) centering around the mouth edge is calculated. In order to calculate the similarity, a pattern matching method such as the subspace method (above-mentioned) or the projection distance method is used.

“n” points of high rank of the similarity are extracted from each candidate point. The number of points “n” is determined by previous test as a minimum not to miss the candidate point near a correct answer. As a result, the one point-normalization pattern recognition unit 130 outputs “nₗₘ” candidate points of the left side mouth edge, “nᵣₘ” candidate points of the right side mouth edge, and the similarity of each candidate point.

The two points-normalization pattern recognition unit 140 sets a pair of both mouth edges by combining one candidate point of the left side mouth edge with one candidate point of the right side mouth edge. A number of the pairs is “nₗₘ×nᵣₘ”.

As for each pair of both mouth edges, a distance between two candidate points of both mouth edges, and a vector between the two candidate points can be calculated. In the same way, by using positions of both pupils (obtained by the base feature point detection unit 112) , a distance and a vector between both pupils can be calculated. Accordingly, a ratio of the distance between both pupils to the distance between the two candidate points of both mouth edges, and an angle between the vector between both pupils to the vector between the two candidate points of both mouth edges are restrictively set. As a result, a pair of two candidate points of both mouth edges having high possibility of geometrical error is excluded, and the processing can be quickly executed.

In the same way as the two points-normalization pattern recognition unit of the first embodiment, a pair of two candidate points of both mouth edges can be extracted by normalizing a pattern including the pair based on the distance/vector between two candidate points. Accordingly, in comparison with one point-normalization pattern, the pattern having size/direction correctly normalized can be extracted. A similarity between two points-normalization pattern of the pair of candidate points of both mouth edges and a template (previously registered) of normalization pattern of both mouth edges is calculated. In order to calculate the similarity, in the same way as the one point-normalization pattern recognition unit, a pattern matching method such as the subspace method (above-mentioned) or the projection distance method is used.

A weighting sum of the similarity of the two points-normalization pattern of the pair, the similarity of the candidate point of the left side mouth edge (in the pair), and the similarity of the candidate point of the right side mouth edge (in the pair) are calculated. “nₗᵣₘ” pairs of high rank each having the maximum weighting sum are selected as candidate pairs of both mouth edges.

The three points-normalization pattern recognition unit 150 groups three points as a pair of candidate points of both mouth edges and a center of gravity of both pupils. The two pupils are determined as the base feature points. Accordingly, a number of groups of three points (the pair and the center of gravity) is “nₗᵣₘ” same as a number of pairs of candidate points of both mouth edges.

By executing the affine transformation to the group of three points (the pair of both mouth edge, the center of gravity between both pupils), a pattern including the three points is normalized.

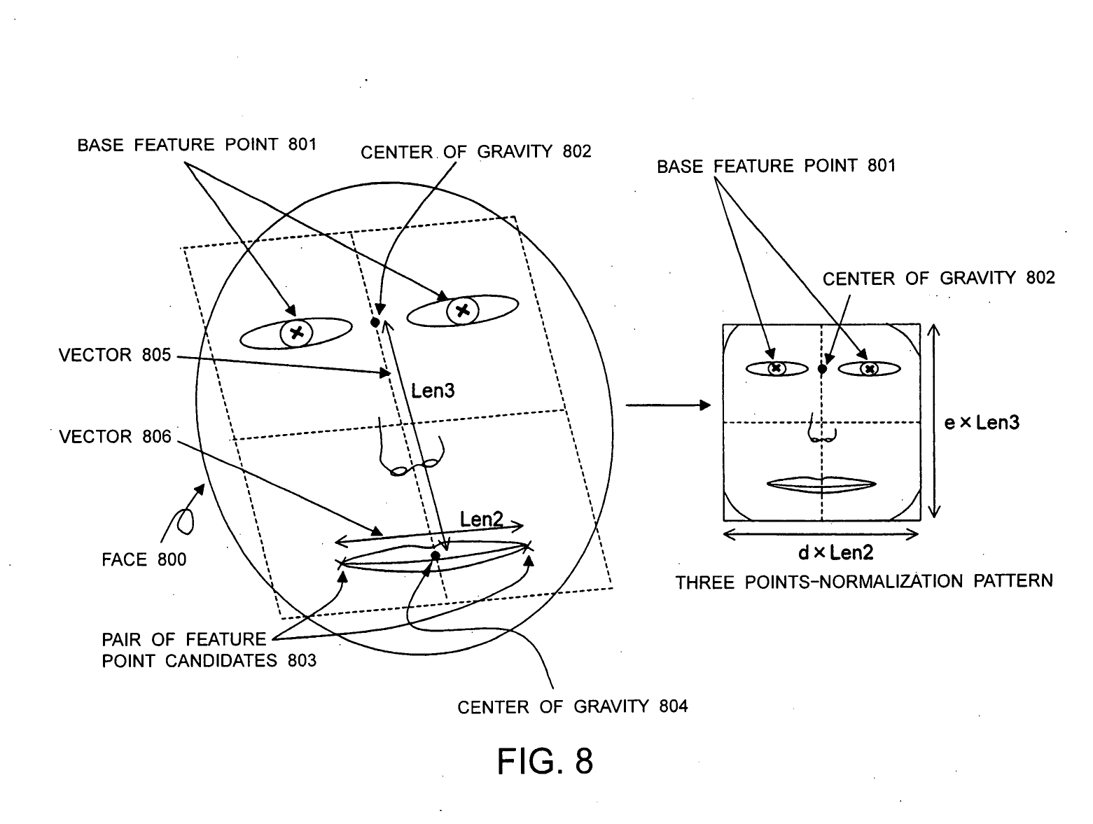

FIG. 8 shows a schematic diagram of a pattern extracted by the three points-normalization pattern recognition unit 150. The left side of FIG. 8 is an example of an original pattern including base feature points 801 and a center of gravity 804 used for three points-normalization. The right side of FIG. 8 is an example of a pattern extracted by three points-normalization.

For example, if a facial image is distorted as shown in the left side of FIG. 8, by extracting a pattern based on a vector 806 between the pair of feature point candidates 803, and a vector 805 between a center of gravity 804 of the pair of feature point candidates 803 and a center of gravity 802 between base feature points 801 (both pupils), the distortion is corrected. In the left side of FIG. 8A, an example of the left side mouth edge and the right side mouth edge is shown as the pair of feature point candidates 803.

Furthermore, assume that a distance between the pair of feature point candidates 803 (a length of the vector 806) is “Lₑₙ 2”, and a distance between the center of gravity 804 of the pair of feature point candidates 803 and the center of gravity 802 between the base feature points 801 (a length of the vector 805) is “Lₑₙ3 ”. The pattern is extracted by a size of the width “d×Lₑₙ 2” and the height “e×Lₑₙ3” as shown in the right side of FIG. 8. Accordingly, personal difference of location of facial parts can be disregarded.

Constants “d” and “e” of the size of the pattern are determined to include a facial area by a previous test. Accordingly, in comparison with one point-normalization pattern and two points-normalization pattern, a pattern correctly normalized for distortion can be extracted.

A similarity between three points-normalization pattern of the group of three points (both mouth edges, the center of gravity of both pupils) and a template (previously registered) of a normalized pattern including the three points is calculated. In case of calculating the similarity, a pattern matching method such as the subspace method (above-mentioned) or the projection distance method is used.

A weighting sum of a similarity of three points-normalization pattern of a group of three points, a similarity of two points-normalization pattern of a pair of candidate points of both mouth edges in the group, a similarity of one point-normalization pattern of a candidate point of the left side mouth edge in the pair, and a similarity of one point-normalization pattern of a candidate point of the right side mouth edge in the pair is calculated. One group of three points having the maximum weighting sum is selected from all groups, and a pair of candidate points of both mouth edges in the one group is regarded as the left side mouth edge and the right side mouth edge.

As mentioned-above, in the feature point detection apparatus of the third embodiment, the base feature point detection unit detects positions of both pupils from a digital image including a person's face. The feature point candidate detection unit detects candidate points of both mouth edges (the left side mouth edge and the right side mouth edge). The one point-normalization pattern recognition unit restrictively selects the candidate points of both mouth edges. The two points-normalization pattern recognition unit restrictively selects pairs of candidate points of both mouth edges from all pairs of candidate points of both mouth edges. The three points-normalization pattern recognition unit restrictively selects one group of three points (both mouth edges, a center of gravity between both pupils) from all groups of three points, and extracts a pair of both mouth edges from the one group.

A pattern normalized using many points is stable for transformation such as scale, rotation, or affine transformation. However, in the prior method, by using many points, a number of combination of candidate points of both mouth edges exponentially increases, and the calculation cost also increases.

In the third embodiment, this problem is solved. Briefly, in the feature point detection apparatus of the third embodiment, before evaluating a combination of feature points detected from the image, the combination is restrictively selected by one point-normalization pattern recognition and two points-normalization pattern recognition. Accordingly, the number of combinations can be reduced.

Furthermore, by calculating a weighting sum of a similarity by one point-normalization pattern, a similarity by two point-normalization pattern and a similarity by three points-normalization pattern, the pair of candidate points of both mouth edges is restrictively selected from all pairs of candidate points of both mouth edges. Accordingly, the pair of both mouth edges can be detected without error.

Briefly, in three points-normalization pattern recognition, in addition to a similarity calculated by the three points-normalization pattern recognition, by using similarities calculated by one point-normalization pattern recognition and two points-normalization pattern recognition, each pair of candidate points of both mouth edges is evaluated. Accordingly, accuracy of detection of candidate points of both mouth edges rises.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), or an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for detecting feature points, comprising:
a storage unit configured to store a first template of a first feature point of an object, a second template of a second feature point of the object, and a third template of a combination of the first feature point and the second feature point;
an image input unit configured to input an image of the object;
a candidate detection unit configured to detect a plurality of first candidates of the first feature point and a plurality of second candidates of the second feature point from the image;
a first pattern recognition unit configured to extract a plurality of third candidates from the plurality of first candidates based on a first similarity between each first candidate and the first template, and to extract a plurality of fourth candidates from the plurality of second candidates based on a second similarity between each second candidate and the second template; and
a second pattern recognition unit configured to generate a plurality of first combinations of each third candidate and each fourth candidate, and to extract a second combination from the plurality of first combinations based on a third similarity between each first combination and the third template.

2. The apparatus according to claim 1, wherein said second pattern recognition unit extracts the second combination from the plurality of first combinations based on the first similarity, the second similarity, and the third similarity.

3. The apparatus according to claim 1, wherein
said storage unit stores a fourth template of a combination of the first feature point, the second feature point, and a third feature point of the object, said
second pattern recognition unit extracts a plurality of second combinations from the plurality of first combinations based on the third similarity, and
said candidate detection unit detects a fifth candidate of the third feature point from the image,
further comprising:
a third pattern recognition unit configured to generate a plurality of third combinations of each second combination and the fifth candidate, and to extract a fourth combination from the plurality of third combinations based on a fourth similarity between each third combination and the fourth template.

4. The apparatus according to claim 3, wherein
said third pattern recognition unit extracts the fourth combination from the plurality of third combinations based on the first similarity, the second similarity, the third similarity and the fourth similarity.

5. The apparatus according to claim 3, wherein
the object is a person's face, and
said candidate detection unit detects a position of both pupils or both nostrils from the image, and detects the fifth candidate based on the position from the image.

6. The apparatus according to claim 3, wherein
the first template, the second template, the third template, and the fourth template include brightness information and gradient information of a brightness, and
the first similarity, the second similarity, the third similarity, and the fourth similarity are respectively a weighting sum of an evaluation value of the brightness information and an evaluation value of the gradient information.

7. The apparatus according to claim 1, wherein
the object is a person's face, and
said candidate detection unit detects the first candidate and the second candidate from a facial area of the image.

8. The apparatus according to claim 7, wherein
said candidate detection unit calculates a size of the facial area,
said first pattern recognition unit calculates the first similarity and the second similarity after normalizing a first area of the first candidate and a second area of the second candidate, or the first template and the second template based on the size of the facial area, and
said second pattern recognition unit calculates the third similarity after normalizing an area of the first combination or the third template based on the size of the facial area.

9. The apparatus according to claim 8, wherein
said candidate detection unit detects a position of both pupils or both nostrils from the image, and sets a detection area of the first candidate and the second candidate based on the position in the image.

10. The apparatus according to claim 9, wherein
said first pattern recognition unit calculates the first similarity and the second similarity after normalizing a rotation and a scale of the first area and the second area, or the first template and the second template based on the position.

11. A method for detecting feature points, comprising:
storing in a memory, a first template of a first feature point of an object, a second template of a second feature point of the object, and a third template of a combination of the first feature point and the second feature point;
inputting an image of the object;
detecting a plurality of first candidates of the first feature point and a plurality of second candidates of the second feature point from the image;
extracting a plurality of third candidates from the plurality of first candidates based on a first similarity between each first candidate and the first template;
extracting a plurality of fourth candidates from the plurality of second candidates based on a second similarity between each second candidate and the second template;
generating a plurality of first combinations of each third candidate and each fourth candidate;
extracting a second combination from the plurality of first combinations based on a third similarity between each first combination and the third template.

12. The method according to claim 11, wherein
the second combination is extracted from the plurality of first combinations based on the first similarity, the second similarity, and the third similarity.

13. The method according to claim 11, further comprising:
storing a fourth template of a combination of the first feature point, the second feature point, and a third feature point of the object in the memory;
extracting a plurality of second combinations from the plurality of first combinations based on the third similarity;
detecting a fifth candidate of the third feature point from the image;
generating a plurality of third combinations of each second combination and the fifth candidate; and
extracting a fourth combination from the plurality of third combinations based on a fourth similarity between each third combination and the fourth template.

14. The method according to claim 13, wherein
the fourth combination is extracted from the plurality of third combinations based on the first similarity, the second similarity, the third similarity, and the fourth similarity.

15. The method according to claim 13, wherein
the object is a person's face,
further comprising:
detecting a position of both pupils or both nostrils from the image; and
detecting the fifth candidate based on the position from the image.

16. The method according to claim 13, wherein
the first template, the second template, the third template, and the fourth template include brightness information and gradient information of a brightness, and
the first similarity, the second similarity, the third similarity and the fourth similarity are respectively a weighting sum of an evaluation value of the brightness information and an evaluation value of the gradient information.

17. The method according to claim 11, wherein
the object is a person's face,
further comprising:
detecting the first candidate and the second candidate from a facial area of the image.

18. The method according to claim 17, further comprising:
calculating a size of the facial area;
calculating the first similarity and the second similarity after normalizing a first area of the first candidate and a second area of the second candidate, or the first template and the second template based on the size of the facial area; and
calculating the third similarity after normalizing an area of the first combination or the third template based on the size of the facial area.

19. The method according to claim 18, further comprising:
detecting a position of both pupils or both nostrils from the image; and
setting a detection area of the first candidate and the second candidate based on the position in the image.

20. The method according to claim 19,
calculating the first similarity and the second similarity after normalizing a rotation and a scale of the first area and the second area, or the first template and the second template based on the position.

21. A computer program product, comprising:
a computer readable program code embodied in said product for causing a computer to detect feature points, said computer readable program code comprising instructions of:
storing in a memory, a first template of a first feature point of an object, a second template of a second feature point of the object, and a third template of a combination of the first feature point and the second feature point;
inputting an image of the object;
detecting a plurality of first candidates of the first feature point and a plurality of second candidates of the second feature point from the image;
extracting a plurality of third candidates from the plurality of first candidates based on a first similarity between each first candidate and the first template;
extracting a plurality of fourth candidates from the plurality of second candidates based on a second similarity between each second candidate and the second template;
generating a plurality of first combinations of each third candidate and each fourth candidate; and
extracting a second combination from the plurality of first combinations based on a third similarity between each first combination and the third template.
